(19) United States
(12) Patent Application Publication
(10) Pub. No.: US 2015/0268961 A1
(43) Pub. Date: Sep. 24, 2015

(54) DECOUPLING L2 BTB FROM L2 CACHE TO ACCELERATE SEARCH FOR MISS AFTER MISS

(71) Applicant: Samsung Electronics Co., Ltd., Suwon-si (KR)

(72) Inventors: Gerald D. ZURASKI, Austin, TX (US); Vikas K. SINHA, Austin, TX (US); David M. MIELKE, Austin, TX (US); Paul E. KITCHIN, Austin, TX (US)

(21) Appl. No.: 14/463,638

(22) Filed: Aug. 19, 2014

Related U.S. Application Data
(60) Provisional application No. 61/969,075, filed on Mar. 21, 2014.

(51) Int. Cl. G06F 9/38; G06F 12/08

(52) U.S. Cl. CPC G06F 9/3806; G06F 12/0875; G06F 2212/6022; G06F 2212/452

(57) ABSTRACT

According to one general aspect, a method may include requesting, from a second tier of a cache memory system, a first instruction stored at a first memory address. The method may also include requesting, from a second tier of a branch target buffer system, a branch record associated with the first memory address. The method may also include receiving the branch record before receiving the first instruction. The method may also include pre-fetching, in response to receiving the branch record and before receiving the first instruction, a non-sequential instruction stored at a non-sequential memory address.

### CROSS-REFERENCE TO RELATED APPLICATION

This application claims priority under 35 U.S.C. §119 to Provisional Patent Application Ser. No. 61/969,075, entitled “DECOUPLING L2 BTB FROM L2 CACHE TO ACCELERATE SEARCH FOR MISS AFTER MISS” filed on Mar. 21, 2014. The subject matter of this earlier filed application is hereby incorporated by reference.

### TECHNICAL FIELD

This description relates to memory management, and, more specifically, to the retrieval of data after an instruction cache miss.

### BACKGROUND

Generally, computers and the programs executed by them have a voracious appetite for unlimited amounts of fast memory. Unfortunately, memory (especially fast memory) is generally expensive both in terms of cost and die area. The traditional solution to the desire for unlimited, fast memory is a memory hierarchy or system of tiers or levels of memories. In general, the tiered memory system includes a plurality of levels of memories, each level slower but larger than the previous tier.

A typical computer memory hierarchy may include three levels. The fastest and smallest memory (often called a “Level 1 (L1) cache”) is closest to the processor and includes static random access memory (SRAM). The next tier or level is often called a Level 2 (L2) cache, and is larger but slower than the L1 cache. The third level is the main memory and generally includes dynamic RAM (DRAM), often inserted into memory modules. However, other systems may have more or less memory tiers. Also, in some systems, the processor registers and the permanent or semi-permanent storage devices (e.g., hard drives, solid-state drives, etc.) may be considered part of the memory system.

The memory system generally makes use of a principle of inclusiveness, wherein the slowest but largest tier (e.g., main memory, etc.) includes all of the data available. The second tier (e.g., the L2 cache, etc.) includes a sub-set of that data, and the next tier from that (e.g., the L1 cache, etc.) includes a second sub-set of the second tier's subset of data, and so on. As such, all data included in a faster tier is also included by slower tier.

Generally, the caches decide what sub-set of data to include based upon the principle of locality (e.g., temporal locality, spatial locality, etc.). It is assumed that a program will wish to access data that it has either recently accessed or is next to the data it has recently accessed. For example, if a movie player program is accessing data, it is likely that the movie player will want to access the next few seconds of the movie, and so on.

However, occasionally a program will request a piece of data that is not available in the fastest cache (e.g., the L1 cache, etc.). That is generally known as a “cache miss” and causes the fastest cache to request the data from the next memory tier (e.g., the L2 cache). This is costly to processor performance as a delay is incurred in determining that a cache miss has occurred, retrieving the data by the L1 cache, and providing it to the processor. Occasionally, the next tier of memory (e.g., the L2 cache, etc.) may not include the requested data and must request it from the next tier (e.g., main memory, etc.). This generally costs further delays.

### SUMMARY

According to one general aspect, a method may include requesting, from a second tier of a cache memory system, a first instruction stored at a first memory address. The method may also include requesting, from a second tier of a branch target buffer system, a branch record associated with the first memory address. The method may also include receiving the branch record before receiving the first instruction. The method may also include pre-fetching, in response to receiving the branch record and before receiving the first instruction, a non-sequential instruction stored at a non-sequential memory address.

According to another general aspect, an apparatus may include a level 1 cache configured to, in response to a cache miss, request an instruction from a level 2 cache. The apparatus may also include a level 1 branch target buffer configured to, in response to a buffer miss, request a branch record from a decoupled level 2 branch target buffer, wherein the branch record is associated with the instruction. The apparatus may also include the decoupled level 2 branch target buffer configured to provide the branch record to the level 1 branch target buffer before the instruction is provided to the level 1 cache. The apparatus may also include a branch prediction circuit configured to, in response to the branch record being provided to the level 1 branch target buffer and before the instruction is provided to the level 1 cache, pre-fetch a non-sequential instruction.

According to another general aspect, a system may include an execution unit configured to request an instruction from a tiered memory system, wherein requesting the instruction causes both a cache miss and a buffer miss. The system may also include the tiered memory system that includes a level-1 cache configured to, in response to the cache miss, request the instruction from a level 2 cache, a level 1 branch target buffer configured to, in response to the buffer miss, request a branch record from a level 2 branch target buffer, wherein the branch record is associated with the instruction, the level 2 branch target buffer configured to provide the branch record to the level 1 branch target buffer before the instruction is provided to the level 1 cache, and the level 2 cache configured to store the instruction, wherein the level 2 cache does not comprise the level 2 branch target buffer. The system may further include an instruction pre-fetch unit configured to, before the instruction is provided to the level 1 cache, pre-fetch a non-sequential instruction, based upon the branch record and via a primary branch predictor pre-fetch circuit, and based upon the a sequential pre-fetch hint, pre-fetch a sequential instruction.

The details of one or more implementations are set forth in the accompanying drawings and the description below. Other features will be apparent from the description and drawings, and from the claims.

A system and/or method for memory management, and more specifically to the retrieval of data after a cache miss, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a timing diagram of an example embodiment of a technique in accordance with the disclosed subject matter.

FIG. 3 is a flowchart of an example embodiment of a technique in accordance with the disclosed subject matter.

FIG. 4 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

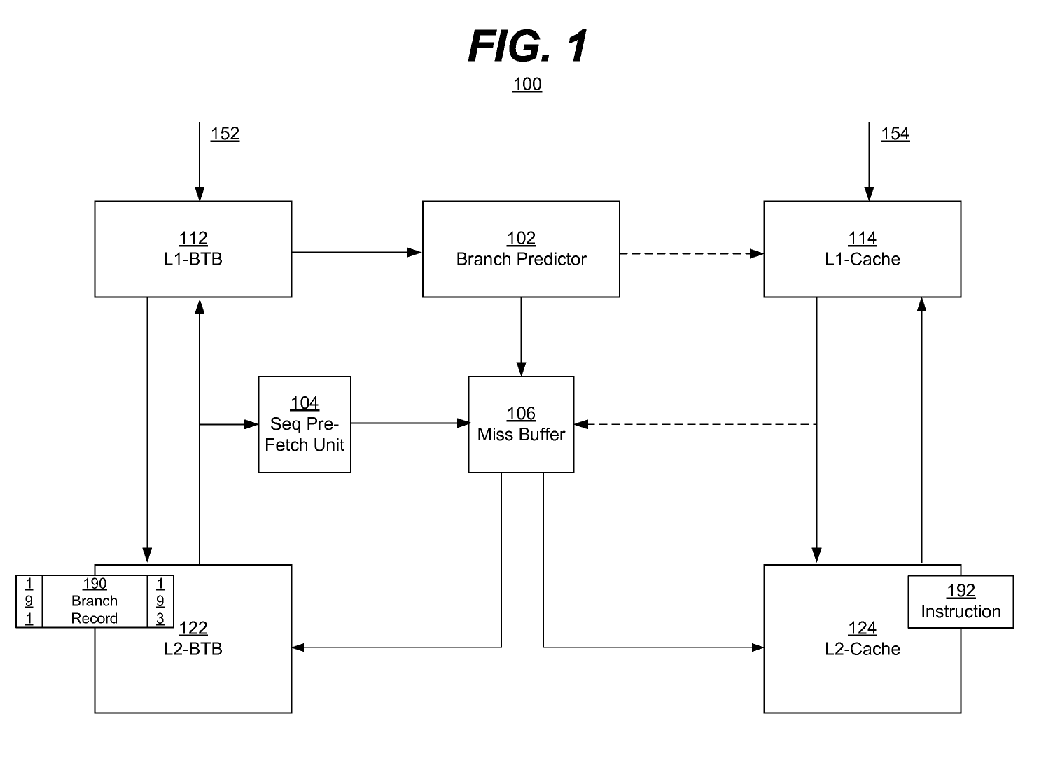

FIG. 1 is a block diagram of an example embodiment of a system 100 in accordance with the disclosed subject matter. In the illustrated embodiment, an execution unit (e.g., an instruction fetch unit (IFU), an instruction decode unit (IDU), a load/store unit (LSU), etc.; and not shown) may attempt to access an instruction from the cache or more generally the memory system (which includes a tiered system of caches and longer-term memories).

In the illustrated embodiment, the system 100 may include a level 1 (L1) cache (L1-cache) 114. In various embodiments, the illustrated L1-cache 114 may be a dedicated instruction L1-cache (as opposed to a combined data & instruction cache). In various embodiments, the L1-cache 114 may be configured to store data representing instructions for various execution units (e.g., a floating-point unit (FPU), an arithmetic logic unit (ALU), etc.). In such embodiments, each instruction may be stored at or accessible via a memory address.

In the illustrated embodiment, an instruction fetch command 154 may request access to the instruction or data stored at a given memory address. As described above, in various embodiments, a tiered memory system may include various levels of memory in which the higher tiers are faster but include less data. In the illustrated embodiment, the requested data may not be included in the L1-cache 114. As described above, this may be referred to as a “cache miss”. In another embodiment, the data may be included in the L1 cache 114, but such an instance is not the primary focus of this document.

As described above, when a cache miss occurs, the faster cache (e.g., the L1 cache 114) typically requests the data from the next memory tier (e.g., the L2 cache 124). In the illustrated embodiment, the system 100 may include a level 2 (L2) cache (L2 cache) 124 configured to store data. In various embodiments, the L2 cache 124 may include a copy of the data stored in the L1 cache 114 and additional data not currently stored within the L1 cache 114. Unlike the L1-cache 114, in various embodiments, the L2 cache 124 may be unified and include both data and instructions. It is understood that the above is merely one illustrative example to which the disclosed subject matter is not limited.

As described above, when a cache miss occurs in the L1 cache 114, the L1 cache 114 may request the missed or missing data from the L2 cache 124. In some embodiments, L2 cache 124 may have the missing data and may supply that data to the requesting L1 cache 114. As described above, this process may take a certain amount of time. In another embodiment, the L2 cache 124 may not have the missing data and may be required to request the missing data from the next or lower tier in the memory system (e.g., main memory, etc.; not shown). This may cause even more delay.

In the illustrated embodiment, the system 100 may also include an L1 Branch Target Buffer (BTB) 112. In various embodiments, the L1 BTB 112 may be configured to store or include predicted branch target memory addresses. In various embodiments, the L1-BTB 112 may not include or store a prediction as to whether the branch will be “taken” or “not taken”. It is understood that the above is merely one illustrative example to which the disclosed subject matter is not limited.

In this context, a “branch instruction” may include an instruction that causes the program flow to jump or change in a non-sequential or continuous fashion. For example, a typical program flow may include instructions sequentially stored at, for example, memory addresses 120, then 121, then 122, and then 123, etc. However, if a branch instruction occurs at memory address 123, the branch instruction may change the program flow to jump to memory address 456 (as opposed to continuing to address 124). It is understood that the above is merely one illustrative example to which the disclosed subject matter is not limited.

Sometimes, a branch instruction is conditional, meaning that where the program jumps to depends upon a variable or argument associated with the instruction (e.g., did the user click a certain button?; is today Tuesday?; does the variable X have a value greater than 10?; etc.). In which case, the branch may go to one of two or more memory addresses. In modern pipelined computer architectures, predicting which of the two or more memory addresses will be selected by the conditional branch instruction is important, because if the wrong choice is made the pipeline must generally be flushed and restarted with the correct choice. In such an embodiment, a branch is considered “taken” if the next instruction executed is defined by the argument of the branch instruction. Likewise the branch is “not taken” when the next instruction executed is the instruction immediately following the branch instruction in memory so that the program flow is unchanged.

Examples of branch statements may include “jump”, “jump if zero”, “jump if overflow”, “branch”, “branch if greater than”, etc. These low-level or machine-level jump instructions may be the result of the high level or human-readable programming language statements such as, for example, the if-statement, a while-loop, a subroutine call, the goto statement, the throw-catch construct, etc. It is understood that the above are merely a few illustrative examples to which the disclosed subject matter is not limited.

In the illustrated embodiment, the L1-BTB 112 may receive a request 152 to look up the memory address of the instruction referenced in the instruction fetch command 154, and report the prediction information associated with that memory address (e.g., the predicted target memory address, etc.). In various embodiments, the L1-BTB request may occur before it is known that the requested instruction is a branch instruction. In such an embodiment, request 152 and request 154 may occur substantially simultaneously. It is understood that the above is merely one illustrative example to which the disclosed subject matter is not limited.

In the illustrated embodiment, the BTB may be tiered similarly to the cache system. In such an embodiment, the L1 BTB 112 may be relatively small but relatively fast, and may only include a sub-set of all the possible encountered branch instructions. In the illustrated embodiment, a second tier of the BTB system may include a level 2 (L2) BTB (L2 BTB) 122 that, similarly to the L2 Cache 124 is larger but slower than the L1 BTB 112. In some embodiments, further BTB tiers may exist. It is understood that the above is merely one illustrative example to which the disclosed subject matter is not limited.

In the illustrated embodiment, the BTB request 152 may request information for a memory address that is not currently stored in the L1 BTB 112, and cause a BTB miss. In such an embodiment, the L1 BTB 112 may request the BTB information from the L2 BTB 122 in a technique similar to that of the cache miss described above. In this context, the information associated with the various memory addresses may be referred to as “branch records”.

In the illustrated embodiment, the L2 BTB 122 may be decoupled or separate from the L2 cache 124. Traditionally, the L2 BTBs are integrated with or part of the L2 cache structure and therefore are subject to the limitations such a large, unified (i.e. data and instruction) cache incurs. However, in the illustrated embodiment, by decoupling or separating the L2 BTB 122 from the L2 cache 124, the L2 BTB 122 may be significantly faster than its traditional counterpart.

For example, in one specific embodiment, the size of the L2 BTB 122 may be less than half of the L2 cache 124. In one embodiment, the size of the individual branch records may be less than half the size of an instruction cache line. Therefore, the number of bits needed to be stored for the decoupled L2 BTB 122 may be significantly reduced, without reducing the number of branch records stored. In such an embodiment, the latency when accessing the L2 BTB 122 (e.g., the time between requesting a branch record and receiving the branch record, etc.) may be half (or less) than the latency when accessing the L2 cache 124. In such an embodiment, the L1 BTB 112 (and the system 100 in general) may recover from the L1 BTB miss far sooner than the L1 cache 114 recovers from the L1 cache miss, as described below. Further, in various embodiments, decoupling the L2 BTB 122 from the L2 cache 124 may incur only negligible area and power overhead, as compared to an integrated L2 BTB and Cache. It is understood that the above are merely a few illustrative examples to which the disclosed subject matter is not limited.

As described above, the decoupled L2 BTB 122 may respond with the requested branch record 190 significantly earlier than the L2 cache 124 responds with the requested instruction 192 or cache line. In the illustrated embodiment, this branch record 190 may only be “half” or part of the information requested by the commands 152 and 154 (the other “half” being the instruction 192). However, this “half” may include enough information for the system 100 to begin to anticipate future actions, and by processing the branch record 190 the system 100 may pre-compute some data and pre-fetch other data. Specifically, in the illustrated embodiment, this may allow the system 100 to begin to pre-fetch data or instructions before the requested instruction 192 has been returned. Additionally, in the illustrated embodiment, this may allow the taken/not-taken determination to be computed or predicted before the requested instruction 192 has been returned. It is understood that the above are merely a few illustrative examples to which the disclosed subject matter is not limited.

In the illustrated embodiment, the system 100 may include a branch prediction circuit or branch predictor 102. In various embodiments, the branch predictor 102 may be configured to predict whether or not the branch instruction will be taken or not taken. In some embodiments, the branch predictor 102 may be very complex as the longer a computer or processor pipeline becomes the more penalty is incurred in mis-predicting the result of the branch instruction, as more pipeline stages must be flushed if the prediction is incorrect. Further discussion of the prediction capabilities of the branch predictor 102 are discussed below, but for now the pre-fetching capabilities of one embodiment will be discussed.

In various embodiments, once the branch record 190 has been returned to the L1-BTB 112, the branch record 190 may be examined to determine the branch prediction information. In one embodiment, the branch prediction information may include a new or target memory address to be used if the branch is taken. This information may be passed or forwarded to the branch predictor 102. In various embodiments, this predicted memory address may be non-sequential or non-continuous in regards to the regular program flow. It is understood that the above is merely one illustrative example to which the disclosed subject matter is not limited.

In such an embodiment, the system 100 may be configured to pre-fetch the non-sequential memory address. In one, less preferred embodiment, the branch predictor 102 may be configured to request the non-sequential memory address or instruction from the L1 cache 114. If the L1 cache 114 does not currently include the memory address a cache miss may occur and the memory address may be requested from the L2 cache 124, as described above. In another, more preferred embodiment, the branch predictor 102 may instead be configured to directly place the non-sequential memory address in the miss buffer 106.

In various embodiments, the system 106 may include a miss queue or miss buffer 106. In such an embodiment, the miss buffer 106 may be configured to queue or store instruction requests or requests for memory addresses and the data stored therein. In various embodiments, the miss buffer 106 may be similar to a more traditional cache fill buffer (not shown) that allows a cache misses to be queued and not blocked by the limitations of the associated memory (e.g. the L1 cache 114, etc.). In another embodiment, the miss buffer 106 may be included by a fill buffer. It is understood that the above are merely a few illustrative examples to which the disclosed subject matter is not limited.

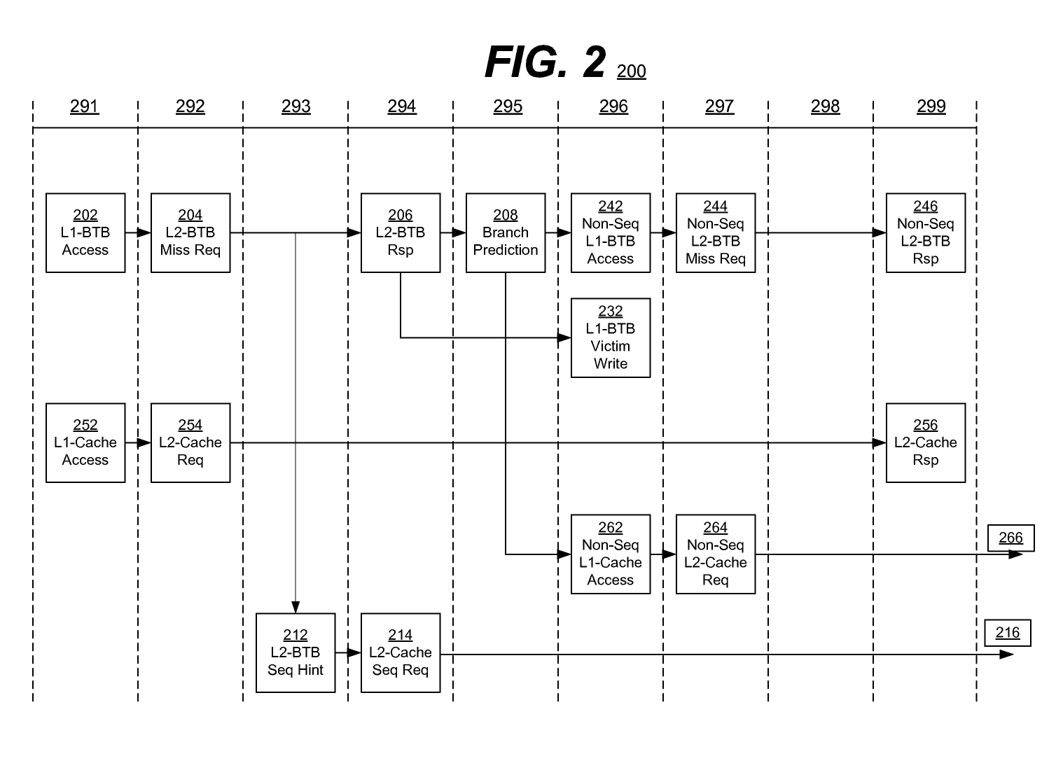

In the illustrated embodiment, the miss buffer 106 may be configured to issue a request to the L2 cache 124 for the pre-fetch data (or instruction) stored at the non-sequential memory address. In various embodiments, and shown more explicitly in FIG. 2, this may occur before the L2-cache 124 has returned the instruction 192 that was requested by the L1 cache 114 as a result of the cache miss that occurred due to the instruction fetch command 154.

In various embodiments, the system 100 may not just use the branch predictor 102 to request or pre-fetch a non-sequential instruction. In such an embodiment, the system 100 may also pre-fetch a sequential instruction. In such an embodiment, the system 100 may pre-fetch future instructions for both the taken and not taken cases for a given branch instruction.

In the illustrated embodiment, the system 100 may include a sequential pre-fetch unit 104. In various embodiments, the sequential pre-fetch unit 104 may be configured to request the next or sequential instruction. In such an embodiment, the request may be placed into the miss buffer 106, as described above. In various embodiments, the sequential pre-fetch instruction may be processed by the miss buffer 106 similarly to the non-sequential pre-fetched instruction described above.

In some embodiments, the branch record 190 may include a sequential pre-fetch hint 191. In such an embodiment, the sequential pre-fetch hint 191 may be configured to indicate whether the sequential pre-fetch data or instruction is worth pre-fetching or is likely to be accessed or used by an execution unit. In various embodiments, the sequential pre-fetch hint 191 may indicate the confidence in the “not taken” possibility of the branch instruction. In such an embodiment, the sequential pre-fetch hint 191 may be employed to filter out useless or undesirable sequential pre-fetch actions.

In some embodiments, the branch record 190 may be accessed by a key or a cache-line tag. In such an embodiment, the branch record 190 may be similar to an element of an associative array in that it has a key portion (e.g., the cache-line tag) and a value portion (e.g., the target memory address if the branch instruction will be taken, etc.). In various embodiments, the cache-line tag may include the memory address of the associated instruction. In another embodiment, the value portion of the branch record 190 may include the target memory address and a classification of the type of branch instruction. In yet another embodiment, the value portion of the branch record may further include a bias weight field 193, as described below. It is understood that the above are merely a few illustrative examples to which the disclosed subject matter is not limited.

In one such an embodiment, the sequential pre-fetch hint 191 may be included within the cache-line tag. In some embodiments, the sequential pre-fetch hint 191 may include one or more bits appended and/or prefixed to the memory address of cache-line tag. In another embodiment, the sequential pre-fetch hint 191 may be encoded within the cache-line tag (e.g., XORed with the memory address, etc.). It is understood that the above are merely a few illustrative examples to which the disclosed subject matter is not limited.

In such an embodiment, by placing the sequential pre-fetch hint 191 within a readily accessible location, such as the cache-line tag, the system 100 may be able to quickly make a decision whether to pre-fetch the sequential instruction or not. In such an embodiment, pre-fetching or requesting the next or sequential instruction may occur dynamically, based upon the sequential pre-fetch hint 191 or lack thereof. It is understood that the above is merely one illustrative example to which the disclosed subject matter is not limited.

In various embodiments, the L2 BTB 122 may include a cache line address tag and then a sub-tag within cache line that include the specific branch address. In some embodiments, storing the sequential pre-fetch hint 191 within the cache line address structure may allow even faster reload latency. It is understood that the above is merely one illustrative example to which the disclosed subject matter is not limited.

Traditionally, a first instruction fetch command 154 would cause the cache miss described above. Once the first instruction 192 was supplied by the L2 cache 124 and processed, the branch predictor 102 would make a prediction based upon that first instruction 192 and a second instruction fetch command 154 would be issued. This second instruction fetch command 154 would be likely to cause a second cache miss (as the first instruction was a miss). Again, the pipeline would stall as the second instruction would be requested from the L2 cache 124. This would cause two full cache miss delays to occur back-to-back. Likewise, third and subsequent instruction fetches may cause delays if those instructions are not in the L1 cache 114.

However, in the illustrated embodiment, by allowing the branch predictor 102 and sequential pre-fetch unit 104 to begin pre-fetching instructions as soon as the branch record 190 has been returned by the L2 BTB 122, and not waiting until the instruction 192 has been returned by the L2 cache 124, the delay caused by subsequent cache misses may be reduced. In various embodiments, the reduction may essentially be the difference between the time the L2 BTB 122 returns the branch record 190 and the time the L2 cache 124 returns the instruction 192. In another embodiment, the speed advantage of the decoupled L2 BTB 112 may allow for the system 100 to process multiple or subsequent cache misses in a substantially simultaneous or overlapping manner.

In a specific embodiment, the second cache miss (e.g., caused by the predicted non-sequential memory address generated by the branch predictor 102) may be launched in a way that hides nearly half the cache miss delay. Further, in various embodiments, if third and subsequent cache misses occur due to additional pre-fetched instruction requests, those third and subsequent delays may be fully or mostly hidden from the execution unit (as they would have been loaded or pre-fetched into the L1 cache 114 before the execution unit attempted to access the instruction). It is understood that the above are merely a few illustrative examples to which the disclosed subject matter is not limited.

In some embodiments, the miss buffer 106 may also be configured to request the branch record 190 associated with the predicted memory address from the L2 BTB 122. In such an embodiment, the branch records 190 associated with the pre-fetched sequential and/or non-sequential memory addresses may be pre-fetched into the L1 BTB 112.

In various embodiments, the branch predictor 102, sequential pre-fetch unit 104, and/or the miss buffer 106 may be configured to check if the pre-fetched non-sequential and/or sequential instruction is already stored within the L1 cache 114 or L1 BTB 112, respectively. If so, the pre-fetched instructions/branch records may not be re-requested from the L2 cache 124 or L2 BTB 122. In various embodiments, such checking may be part of the normal branch predictor 102, sequential pre-fetch unit 104, and/or the miss buffer 106 pipeline or order of operations. It is understood that the above is merely one illustrative example to which the disclosed subject matter is not limited.

As briefly described above, in various embodiments, when the branch record 190 from the first cache miss has been returned from the L2 BTB 122, the branch predictor 102 may begin to predict whether the branch will be “taken” or “not taken”. In such an embodiment, this may allow the system 100 to determine whether the sequential or non-sequential instructions should be pursued before the instruction 192 is retuned from the L2 cache 124. In such an embodiment, the system 100 may not have to wait (or wait less than is traditional) before proceeding with the execution of the program (of which the instruction 192 is a part).

In various embodiments, the branch record 190 may include a bias weight field 193 that includes a branch prediction value. The branch prediction value may be used to train the branch predictor 102.

As described above, branch predictors 102 tend to be fairly complex and often employ a weighted branch prediction scheme (as opposed to a simple binary take/don't-take scheme). In various embodiments, as a branch is processed a number of times (e.g., due to an iterative loop, etc.) the branch predictor 102 may increase or decrease a prediction weight used to predict whether or not the branch will be taken or not-taken the next time the branch instruction is encountered. Traditionally, when a branch record 190 is evicted or removed from the L1 BTB 112 (to make room for a new branch record) the complex and nuanced weight used for branch prediction is lost.

In the illustrated embodiment, the branch record 190 stored within the L2 BTB 122 may include a bias weight field 193 that includes the prediction weight used by the branch predictor 102. This bias weight field 193 or prediction weight may be loaded back into the branch predictor 102 (or the state machines thereof) when the branch record 190 is returned from the L2 BTB 122. In such an embodiment, this may greatly aid the branch predictor 102 in correctly predicting the taken/not-taken state of the branch instruction. In various embodiments, this may be referred to as training the branch predictor 102.

In various embodiments, the bias weight field 193 may be specific to the particular branch instruction or memory address associated with the branch record 190. In some embodiments, the bias weight field 193 may be added to the branch record 190 as it is being evicted from the L1 BTB 112 and may be written to the L2 BTB 122. In such an embodiment, storing the bias weight field 193 within the L2 BTB 122 may prevent it or the prediction weight from being overwritten or modified by competing branches that are still active in the branch predictor 102 after this particular branch record 190 has been evicted from the L1 BTB 112.

In such an embodiment, the bias weight field 193 and its use when the branch record 190 is returned to the L1 BTB 112, may allow for more accurate prediction of most branches immediately upon branch record 190's reload, as the branch predictor 102 need not re-train from scratch. In some embodiments, the bias weight field 193 and its use when the branch record 190 is returned to the L1 BTB 112, may allow for faster branch prediction retaining, and the branch bias or weight may be copied directly to the branch predictor 102

In various embodiments, the sequential fetch unit 104 may be integrated into the branch predictor 102. In another embodiment, the sequential fetch unit 104 and the branch predictor 102 may be integrated into a pre-fetch unit. It is understood that the above are merely a few illustrative examples to which the disclosed subject matter is not limited.

FIG. 2 is a timing diagram of an example embodiment of a technique 200 in accordance with the disclosed subject matter. In various embodiments, the technique 200 may be employed or produced by a system, such as, for example, the system 100 of FIG. 1 or the system of FIG. 5. In the illustrated embodiment, the technique 200 may occur over the course of 14 clock cycles (of which 9 clock cycles are shown in detail). However, it is understood that the latencies and specific timings are merely one illustrative example to which the disclosed subject matter is not limited. For example, in some embodiments, the L2-BTB sequential hint (action 212) may take 1 or 2 clock cycles, the L2-BTB response (action 206) may take 5-10 clock cycles, the L2-Cache response (action 256) may take 10-20 clock cycles, etc. As such, the number of clock cycles shown in FIG. 2 is merely for illustrative purposes. It is understood that the above are merely a few illustrative examples to which the disclosed subject matter is not limited.

In the illustrated embodiment, at time or clock cycle 291, a L1 cache access 252 may occur or be received. As described above, in various embodiments, this L1 cache access 252 may include an instruction access or read operation. Further, as described above, in various embodiments, this L1 cache access 252 may result in a cache miss.

As a result, at time or clock cycle 292, a L2-cache request 254 may be made to an L2 cache for the instruction requested by the L1 cache access 252. In the illustrated embodiment, this L2-cache request 254 may take 7 cycles to complete. It is understood that the above is merely one illustrative example to which the disclosed subject matter is not limited.

In the illustrated embodiment, also at time or clock cycle 291, a L1 BTB access 202 may occur or be received. As described above, in various embodiments, this L1 BTB access 202 may be associated with the same instruction access as the L1 cache access 252. Further, as described above, in various embodiments, this L1 BTB access 202 may result in a cache miss.

As a result, also at time or clock cycle 292, a L2-BTB request 204 may be made to a decoupled L2 BTB for the branch record associated with the instruction requested by the L1 cache access 252. In the illustrated embodiment, as the L2 BTB is decoupled from the L2 cache and may therefore work independently and may be smaller and faster, this L2-BTB request 204 may take a mere 2 cycles to complete. It is understood that the above is merely one illustrative example to which the disclosed subject matter is not limited.

In the illustrated embodiment, at time or clock cycle 293, action 212 illustrates that the system may examine the L2 BTB sequential hint, as described above. In one such embodiment, the L2 BTB sequential hint may be stored within the cache-line tag used in or associated with the L1-BTB associated with L2 BTB and therefore may be available faster than L2-BTB Response 206. In one embodiment, if the L2 BTB sequential hint indicates the sequential instruction would not be useful or is highly unlikely to be used no further action may be taken in this course of events and the sequential or next instruction may not be pre-fetched. Conversely, in another embodiment, the L2 BTB sequential hint may indicate that the sequential instruction might be useful or may, within a predefined threshold value, be likely to be accessed.

In such an embodiment, at time or clock cycle 294, a L2-cache request 214 may be made to the L2 cache for the next or sequential instruction relative to the instruction requested by the L1 cache access 252. As described above, this may occur in some embodiments only if the sequential hit indicates it should or would be useful. In the illustrated embodiment, this sequential L2-cache request 214 may take 7 cycles to complete. In the illustrated embodiment, this is shown as sequential L2 cache response 216 occurring at time or clock cycle 299+2 or 301 (a clock cycle not explicitly shown). It is understood that the above is merely one illustrative example to which the disclosed subject matter is not limited.

Also at time or clock cycle 294, the L2 BTB may return the L2 BTB response 206. In various embodiments, this L2 BTB response 206 may include the requested branch record. As described above, in various embodiments, the branch record may include a bias weight field that may be employed to train the branch predictor. It is understood that the above is merely one illustrative example to which the disclosed subject matter is not limited.

In the illustrated embodiment, the addition of the new branch record (from the L2 BTB response 206) may result in an eviction of an old branch record currently stored in the L1 BTB. Action 232 illustrates that this old branch record may be written back to the L2 BTB. As described above, in various embodiments, action 232 may include writing a bias weight field and/or a sequential pre-fetch hint to the old branch record. In the illustrated embodiment, action 232 is shown as occurring at time or clock cycle 296. However, it is understood that the above is merely one illustrative example to which the disclosed subject matter is not limited.

In the illustrated embodiment, at time or clock cycle 295, action 208 illustrates that the branch prediction may occur. In various embodiments, this branch prediction may be aided by a bias weight field stored within the branch record returned via the L2-BTB response 206. As described above, the branch prediction circuit may also be responsible for determining the target or non-sequential memory address. In various embodiments, the target or non-sequential memory address may be stored within the branch record returned via the L2-BTB response 206.

At time or clock cycle 296, the branch predictor may initiate two actions. The first action may include the non-sequential L1 cache access 262. In various embodiments, the non-sequential L1 cache access 262 may include checking that the target or non-sequential memory address of the branch instruction (from the L1-cache access 252) is or is not within the L1 cache. The second action may include the non-sequential L1 BTB access 242. In various embodiments, the non-sequential L1 BTB access 242 may include checking that a branch record associated with the target or non-sequential memory address is or is not within the L1 BTB. In the illustrated embodiment, it will be assumed that both of these requests result in cache/BTB misses. It is understood that the above is merely one illustrative example to which the disclosed subject matter is not limited.

As a result of this second cache miss, at time or clock cycle 297, a non-sequential L2-cache request 264 may be made to the L2 cache for the instruction requested by the non-sequential L1 cache access 262. Again, in the illustrated embodiment, this L2-cache request 264 may take a 7 cycles to complete. In the illustrated embodiment, this is shown as non-sequential L2 cache response 266 occurring at time or clock cycle 299+5 or 304 (a clock cycle not explicitly shown). It is understood that the above is merely one illustrative example to which the disclosed subject matter is not limited.

As a result of this second BTB miss, also at time or clock cycle 297, a non-sequential L2-BTB request 244 may be made to a decoupled L2 BTB for the branch record associated with the instruction requested by the non-sequential L1 cache access 262. In the illustrated embodiment, this non-sequential L2-BTB request 244 may take a mere 2 cycles to complete and complete at time or clock cycle 299 with the non-sequential L2 BTB response 246. It is understood that the above is merely one illustrative example to which the disclosed subject matter is not limited.

In the illustrated embodiment, also at time or clock cycle 299 the first L2 cache request 254 may complete as the L2 cache response 256 returns with the requested instruction. It is understood that the above is merely one illustrative example to which the disclosed subject matter is not limited.

As described above, in traditional systems once the first requested instruction is retuned the instruction and its associated branch record may be examined, and used for branch prediction etc. In such an embodiment, actions 208, 242, 244, 262, 264, and/or 214 may occur after time or clock cycle 299. In some embodiments, action 214 may occur in clock cycle 293 or 294 without using the prefetch hint.

However, in the illustrated embodiment, because the L2 BTB response 206 occurs much faster than is traditional, the actions 208, 242, 244, and/or 212 and 214 may start to occur as soon as time or clock cycle 294. This means that the instructions requested in the non-sequential L2 cache request 264 may be available up to 8 cycles (or a similar number depending upon the embodiment, as the clock cycle count of FIG. 2 is merely illustrative) before a traditional system may have the next instructional available (e.g., clock cycle 301 versus clock cycle 309). While the speed of the sequential L2 cache request 214 may be improved, the illustrated embodiment allows for the accuracy of the prefetch to be improved compared to a traditional system. It is understood that the above are merely illustrative examples to which the disclosed subject matter is not limited.

As described above, it is understood that the latencies and clock cycle timings of the illustrated embodiment are merely examples to which the disclosed subject matter is not limited. In various embodiments, other latencies, timings, and additional events (e.g., an L2 cache miss, delay incurred due to a miss or fill buffer, etc.) may be included or occur, and are within the scope of the disclosed subject matter.

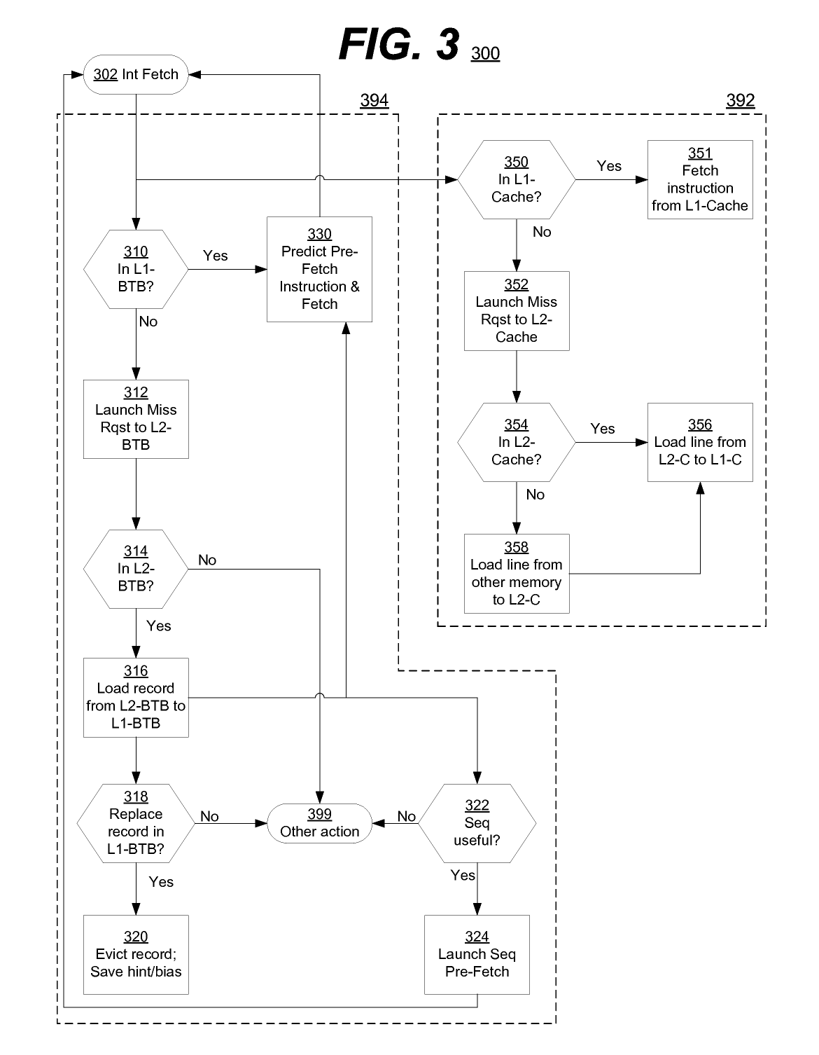

FIG. 3 is a flowchart of an example embodiment of a technique 300 in accordance with the disclosed subject matter. In various embodiments, the technique 300 may be used or produced by the systems such as those of FIG. 1 or 5. Although, it is understood that the above are merely a few illustrative examples to which the disclosed subject matter is not limited. It is understood that the disclosed subject matter is not limited to the ordering of or number of actions illustrated by technique 300.

Block 302 illustrates that, in one embodiment, an instruction fetch command may be received, as described above. Blocks 350 and 310 illustrate that, in one embodiment, both the instruction L1 cache, and the L1 BTB may be checked to determine if the desired instruction (and the instruction's associated branch record) are included in the L1 memories.

Block 351 illustrates that, in one embodiment, if the requested instruction is in the L1-cache (a cache hit) the instruction may be fetched from the L1 cache. Block 352, however, shows the case more thoroughly discussed in this document, in which a cache miss occurs. Block 352 illustrates that, in one embodiment, a miss request for the instruction may be made to the L2 cache.

Block 354 illustrates that, in one embodiment, the L2 cache may be checked to determine if the desired instruction is included in or stored by the L2 cache. Block 356 illustrates that, in one embodiment, if the requested instruction is in the L2-cache (a cache hit) the instruction may be fetched from the L2 cache and supplied to the L1 cache. Block 358, illustrates that, in one embodiment, an L2 cache miss may occur and the desired instruction may be fetched from a lower or slower tier of the memory system (e.g., an L3 cache, main memory, etc.). It is understood that the above are merely a few illustrative examples to which the disclosed subject matter is not limited.

Block 330 illustrates that, in one embodiment, if the requested branch record is in the L1-BTB (a BTB hit) the branch record may be fetched from the L1 BTB. The branch record may then be used to predict the next pre-fetched instruction (e.g., a non-sequential instruction, etc.). This predicted non-sequential instruction may then be pre-fetched in a manner similar to that described above. In the illustrated embodiment, this may include returning to action 302 with the new, non-sequential instruction fetch request and beginning the technique 300 again, but with a different instruction.

Block 312 illustrates that, in one embodiment, if the requested branch record is not in the L1-BTB (a BTB miss) the branch record may be fetched from the L2 BTB, as described above. Block 314 illustrates that, in one embodiment, the L2 BTB may be searched for the requested branch record. If the requested branch record is not in the L2 BTB, action 399 illustrates that some other action may be taken. In various embodiments, the other action may include retrieving the branch record from a lower or slower tier of the memory system (e.g., an L3 cache, an L3 BTB, main memory, etc.), or the action may include reporting to the L1 BTB that such a branch record does not exist. It is understood that the above are merely a few illustrative examples to which the disclosed subject matter is not limited.

Block 316 illustrates that, in one embodiment, the requested branch record may exist within the L2 BTB, and may subsequently be loaded from the L2 BTB to the L1 BTB, as described above. In various embodiments, upon the branch record becoming available to the L1 BTB one or more things may occur. In one embodiment, action 330 may occur in which the non-sequential instruction is determined and fetched, as described above.

Block 318 illustrates that, in one embodiment, a determination may be made as to whether the new branch record (from Block 316) is to replace an existing or old branch record associated with another memory address. If so, Block 320 illustrates that, in one embodiment, the old branch record may be evicted. In various embodiments, before that occurs, a branch bias and/or a sequential pre-fetch hint may be saved to the old branch record, as described above. If an old branch record is not to be evicted, Block 399 illustrates that, in one embodiment, other actions (e.g., no action at all, etc.) may occur. It is understood that the above is merely one illustrative example to which the disclosed subject matter is not limited.

Block 322 illustrates that, in one embodiment, a determination may be made, based, at least in part, upon the sequential pre-fetch hint, if pre-fetching the sequential instruction is likely to be useful or desirable. As described above, in some embodiments, this check may not be made and the sequential instruction may always be pre-fetched. Block 324 illustrates that, in one embodiment, if the hint indicates the sequential instruction may be useful, the sequential instruction may be pre-fetched, as described above. In various embodiments, this may cause the technique 300 to return to Block 302 but with a new instruction to fetch, as described above. In another embodiment, the sequential instruction may simply be fetched from the L2 cache, as described above. In another embodiment, if the sequential hint indicates that the sequential instruction would not be useful, Block 399 illustrates that, in one embodiment, other actions (e.g., not pre-fetching the sequential instruction, etc.) may occur. It is understood that the above is merely one illustrative example to which the disclosed subject matter is not limited. In yet another embodiment, the actions of Block 322 may occur after Block 318 or in response to Block 312, more similarly to that of FIG. 2. Again, it is understood that the above is merely one illustrative example to which the disclosed subject matter is not limited.

In the illustrated embodiment, the actions or blocks included by bounding box 392 may illustrate actions taken in response to the instruction fetch request (Block 302) by the L1 cache and the subsequent tiers of the memory system. Conversely, the actions or blocks included by bounding box 394 may illustrate actions taken in response to the instruction fetch request (Block 302) by the L1 BTB and the system in response to the quicker retrieval times provided by the decoupled L2 BTB. It is understood that the above is merely one illustrative example to which the disclosed subject matter is not limited.

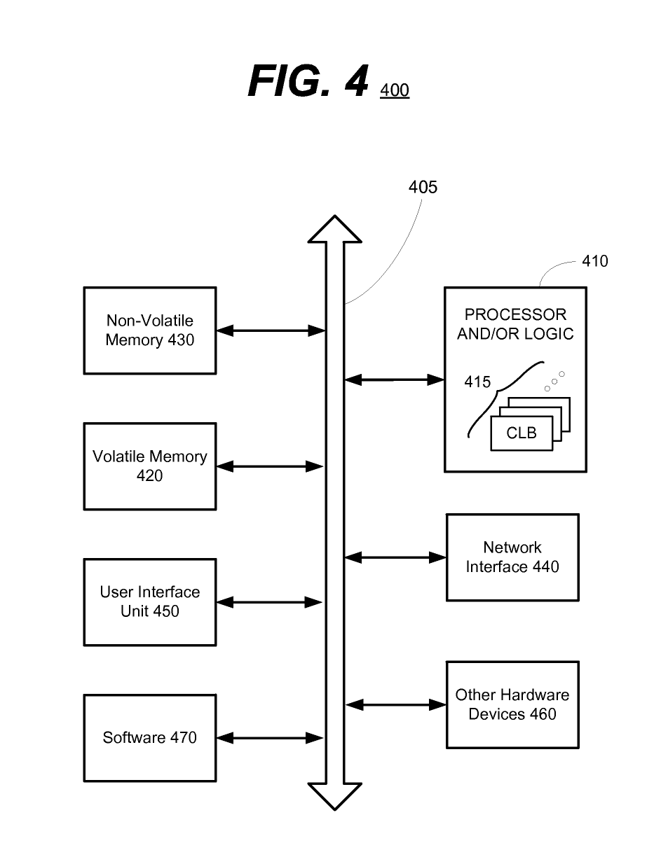

FIG. 4 is a schematic block diagram of an information processing system 400, which may include semiconductor devices formed according to principles of the disclosed subject matter.

Referring to FIG. 4, an information processing system 400 may include one or more of devices constructed according to the principles of the disclosed subject matter. In another embodiment, the information processing system 400 may employ or execute one or more techniques according to the principles of the disclosed subject matter.

In various embodiments, the information processing system 400 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 400 may be used by a user (not shown).

The information processing system 400 according to the disclosed subject matter may further include a central processing unit (CPU), logic, or processor 410. In some embodiments, the processor 410 may include one or more functional unit blocks (FUBs) or combinational logic blocks (CLBs) 415. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 400 according to the disclosed subject matter may further include a volatile memory 420 (e.g., a Random Access Memory (RAM), etc.). The information processing system 400 according to the disclosed subject matter may further include a non-volatile memory 430 (e.g., a hard drive, an optical memory, a NAND or Flash memory, etc.). In some embodiments, either the volatile memory 420, the non-volatile memory 430, or a combination or portions thereof may be referred to as a “storage medium”. In various embodiments, the volatile memory 420 and/or the non-volatile memory 430 may be configured to store data in a semi-permanent or substantially permanent form.

In various embodiments, the information processing system 400 may include one or more network interfaces 440 configured to allow the information processing system 400 to be part of and communicate via a communications network. Examples of a Wi-Fi protocol may include, but are not limited to, Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to, IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 400 according to the disclosed subject matter may further include a user interface unit 450 (e.g., a display adapter, a haptic interface, a human interface device, etc.). In various embodiments, this user interface unit 450 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 400 may include one or more other devices or hardware components 460 (e.g., a display or monitor, a keyboard, a mouse, a camera, a fingerprint reader, a video processor, etc.). It is understood that the above are merely a few illustrative examples to which the disclosed subject matter is not limited.

The information processing system 400 according to the disclosed subject matter may further include one or more system buses 405. In such an embodiment, the system bus 405 may be configured to communicatively couple the processor 410, the volatile memory 420, the non-volatile memory 430, the network interface 440, the user interface unit 450, and one or more hardware components 460. Data processed by the processor 410 or data inputted from outside of the non-volatile memory 430 may be stored in either the non-volatile memory 430 or the volatile memory 420.

In various embodiments, the information processing system 400 may include or execute one or more software components 470. In some embodiments, the software components 470 may include an operating system (OS) and/or an application. In some embodiments, the OS may be configured to provide one or more services to an application and manage or act as an intermediary between the application and the various hardware components (e.g., the processor 410, a network interface 440, etc.) of the information processing system 400. In such an embodiment, the information processing system 400 may include one or more native applications, which may be installed locally (e.g., within the non-volatile memory 430, etc.) and configured to be executed directly by the processor 410 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 410.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, etc.). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. A method comprising:
requesting, from a second tier of a cache memory system, a first instruction stored at a first memory address;
requesting, from a second tier of a branch target buffer system, a branch record associated with the first memory address;
receiving the branch record before receiving the first instruction; and
pre-fetching, in response to receiving the branch record and before receiving the first instruction, a non-sequential instruction stored at a non-sequential memory address.

2. The method of claim 1, wherein pre-fetching the non-sequential instruction comprises retrieving the non-sequential memory address from the branch record and predicting if a non-sequential branch is taken via a primary branch prediction circuit.

3. The method of claim 1, further comprising pre-fetching, before receiving the first instruction, a sequential instruction stored at a sequential memory address.

4. The method of claim 3, wherein pre-fetching the sequential pre-fetched instruction comprises:
checking a sequential pre-fetch hint to determine if the sequential instruction is likely to be accessed by an execution unit; and
if not, refraining from requesting the sequential instruction.

5. The method of claim 3, further comprising:
determining if the sequential instruction was previously accessed by an execution unit; and
storing a sequential pre-fetch hint within the branch record associated with the first memory address.

6. The method of claim 5, wherein storing a sequential pre-fetch hint within the branch record comprises:
storing the sequential pre-fetch hint within a cache-line tag associated with the branch record.

7. The method of claim 1, wherein receiving the branch record comprises:
replacing, within a first tier of a branch target buffer system, an old branch record with the branch record; and
storing a bias weight field within the undesired branch record, wherein the bias weight field comprising a branch prediction value configured to train a branch prediction circuit to make more accurate prediction.

8. The method of claim 1, wherein receiving the branch record comprises:
determining if the branch record comprising a bias weight field; and
if so, training a branch prediction circuit based, at least in part, upon the bias weight field.

9. An apparatus comprising:
a level 1 cache configured to, in response to a cache miss, request an instruction from a level 2 cache;
a level 1 branch target buffer configured to, in response to a buffer miss, request a branch record from a decoupled level 2 branch target buffer, wherein the branch record is associated with the instruction;
the decoupled level 2 branch target buffer configured to provide the branch record to the level 1 branch target buffer before the instruction is provided to the level 1 cache; and
a branch prediction circuit configured to, in response to the branch record being provided to the level 1 branch target buffer and before the instruction is provided to the level 1 cache, pre-fetch a non-sequential instruction.

10. The apparatus of claim 9, wherein the level 2 branch target buffer comprises:
an overall storage capacity less than or equal to half of an overall storage capacity of the level 2 cache, and
a record size storage capacity equal to an instruction cache line storage capacity of the level 2 cache.

11. The apparatus of claim 9, wherein the level 2 branch target buffer comprising a response latency less than or equal to half a response latency of the level 2 cache.

12. The apparatus of claim 9, further comprising a sequential pre-fetch unit configured to pre-fetch a sequential instruction before the instruction is provided to the level 1 cache.

13. The apparatus of claim 12, wherein the sequential pre-fetch unit is configured to:
check a sequential pre-fetch hint to determine if the sequential instruction is likely to be accessed by an execution unit; and
if not, refrain from pre-fetching the sequential instruction.

14. The apparatus of claim 9, wherein the branch record is associated with a cache line tag, and wherein the cache-line tag comprising a sequential pre-fetch hint that indicates if the sequential instruction is likely to be accessed by an execution unit.

15. The apparatus of claim 9, wherein the level 1 branch target buffer is configured to, in response to a receipt of the branch record:
determine an undesired branch record to evict;
store a branch bias within the undesired branch record, wherein the branch bias indicates a branch prediction weight assigned, by the branch prediction circuit, to a branch instruction associated with the undesired branch record; and
store the undesired record with the branch bias within the decoupled level 2 branch target buffer.

16. The apparatus of claim 9, wherein the branch prediction circuit is configured to, in response to a receipt of the branch record:
retrieve a branch bias from the branch record, wherein the branch bias indicates a branch prediction weight previously assigned, by the branch prediction circuit, to a branch instruction associated with the branch record; and
train the branch prediction circuit based, at least in part, upon the branch bias from the branch record.

17. A system comprising:
an execution unit configured to request an instruction from a tiered memory system, wherein requesting the instruction causes both a cache miss and a buffer miss;
the tiered memory system comprising:
a level-1 cache configured to, in response to the cache miss, request the instruction from a level 2 cache,
a level 1 branch target buffer configured to, in response to the buffer miss, request a branch record from a level 2 branch target buffer, wherein the branch record is associated with the instruction,
the level 2 branch target buffer configured to provide the branch record to the level 1 branch target buffer before the instruction is provided to the level 1 cache, and
the level 2 cache configured to store the instruction, wherein the level 2 cache does not comprise the level 2 branch target buffer; and
an instruction pre-fetch unit configured to, before the instruction is provided to the level 1 cache:
pre-fetch a non-sequential instruction, based upon the branch record and via a primary branch predictor pre-fetch circuit, and
based upon the a sequential pre-fetch hint, pre-fetch a sequential instruction.

18. The system of claim 17, wherein the level 2 branch target buffer comprises a response latency less than a response latency of the level 2 cache.

19. The system of claim 17, wherein the instruction pre-fetch unit comprises:
a branch prediction circuit configured to, in response to the branch record being provided to the level 1 branch target buffer, pre-fetch the non-sequential instruction; and
a sequential pre-fetch unit configured to, if indicated to do so by a sequential pre-fetch hint associated with the branch record, pre-fetch a sequential instruction.

20. The system of claim 17, further comprising a branch predictor circuit configured to, in response to a receipt of the branch record:
retrieve a branch bias from the branch record, wherein the branch bias indicates a branch prediction weight previously assigned, by the branch prediction circuit, to a branch instruction associated with the branch record; and
train the branch prediction circuit based, at least in part, upon the branch bias from the branch record.
